(19) United States
(12) Patent Application Publication
(10) Pub. No.: US 2014/0214536 A1
(43) Pub. Date: Jul. 31, 2014

(54) SYSTEMS AND METHODS FOR PROVIDING ONLINE ADVERTISING UTILIZING USER-CENTRIC INTERACTION WITH COMPANIES, PRODUCTS, SERVICES AND CONTENT

(71) Applicant: OSVALDO SILVA, ORLANDO, FL (US)

(72) Inventor: OSVALDO SILVA, ORLANDO, FL (US)

(21) Appl. No.: 14/157,069

(22) Filed: Jan. 16, 2014

Related U.S. Application Data
(60) Provisional application No. 61/756,882, filed on Jan. 25, 2013.

(51) Int. Cl. G06Q 30/02; G06Q 50/00

(52) U.S. Cl. CPC G06Q 30/0255; G06Q 50/01
USPC 705/14.53

(57) ABSTRACT

A computer implemented method is provided for implementing user centric advertising and multiuser communication. The method includes providing a communication interface between advertiser devices, user devices and publisher devices, receiving advertiser preferences from the user devices, matching the preferences with advertisements from the advertiser devices and displaying the matched advertisements on a portal. The method also includes providing functionality for conducting two way communication between select user devices and advertiser devices, and conducting e-commerce transactions. The method also including a social exchange platform with functionality for user to user communication.

### CROSS-REFERENCE TO RELATED APPLICATIONS

This application claims the benefit of U.S. application Ser. No. 61/756,882 filed on Jan. 25, 2013, the contents of which are incorporated herein by reference.

### TECHNICAL FIELD

The present invention relates generally to systems and methods directed toward online advertisement, sales and multi-user communication.

### BACKGROUND

The statements in this section merely provide background information related to the present disclosure and may not constitute prior art.

Over the past several years, the percentage of products and services purchased over the internet has grown substantially. As a result, many companies are abandoning or greatly reducing traditional advertising mediums in favor of new e-commerce oriented advertising platforms. To this end, companies often utilize third party publishers to bombard online consumers with unsolicited ads, popups, and/or website redirects in an attempt to push business towards a particular company.

More recently, online advertisers are utilizing techniques such as tracking cookies, behavioral targeting, and other such methodologies to track and collect data pertaining to consumer activities, in order to generate and display specific advertisements to consumers based on the consumers' website browsing history and/or user profile data. Use of these tracking mediums is extremely unpopular with consumers who value privacy and do not wish to have their internet usage monitored and/or shared with third party websites without the consumer's permission.

In addition to the above, social media sites have drastically changed the way that people communicate. Whether it be with friends, family or other users who share common interests, social media sites have allowed individuals to express themselves and make new friends based on any number of shared interests. Not surprisingly, many of the same online advertising methodologies mentioned above are now being used within social media sites, thereby resulting in the same issues pertaining to consumer privacy.

In addition to the above, many online marketplace websites offer products and services to consumers wherein a consumer is able to make a purchase online and then have their order shipped directly to a desired address. While using these sites, the above noted tracking techniques are employed to suggest additional items to the consumers. This feature is especially disconcerting to consumers because there is fear that the payment information used to make the online purchase could be intercepted by the tracking mechanisms.

As a result of the above, there is a need for a system and method which can create an ecosystem platform having a user centric approach to online advertising. The ecosystem creates a fusion between a social media platform and an online marketplace platform in order to display specific interactive advertisements that are 100% relevant to a consumer based on the consumers stated interests. Such an ecosystem will function to greatly benefit consumers, advertisers and publishers alike, without using the existing online advertising methodologies mentioned above.

### SUMMARY OF THE INVENTION

Systems and methods for providing online advertising utilizing user-centric interaction with companies, products, services and content (also referred to herein as a system and method for conducting user centric advertising and multiuser communication) allows users to interact with other site users and advertisers within an online ecosystem, and to receive 100% relevant content from selected advertisers in a manner that respects user privacy. The ecosystem can include multiple platforms and interfaces capable of facilitating direct communication between the site users and advertisers when desired by the user.

In one embodiment, the ecosystem can provide functionality for embedding portals within publisher interfaces, such as a third party website, for example, wherein site users can access an ecosystem generated social exchange platform, receive advertisements from approved advertisers, and communicate directly with selected advertisers to conduct e-commerce transactions. These features can be accomplished without requiring the user to leave the publishers website.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment according to some embodiments of the technology.

FIG. 2 shows an exemplary flow diagram illustrating a method for joining the Advertiser Platform of the network environment, according to one embodiment.

FIG. 3 shows an exemplary flow diagram illustrating a method for joining the Publisher Platform of the network environment, according to one embodiment.

FIG. 4 shows an exemplary user interface of the ecosystem of FIG. 1.

FIG. 5 shows another exemplary user interface of the ecosystem of FIG. 1.

FIG. 6 shows another exemplary user interface of the ecosystem of FIG. 1.

FIG. 7 shows another exemplary user interface of the ecosystem of FIG. 1.

FIG. 8 shows another exemplary user interface of the ecosystem of FIG. 1.

FIG. 9A shows another exemplary user interface of the ecosystem of FIG. 1.

FIG. 9B shows another exemplary user interface of the ecosystem of FIG. 1.

FIG. 9C shows another exemplary user interface of the ecosystem of FIG. 1.

FIG. 9D shows another exemplary user interface of the ecosystem of FIG. 1.

FIG. 9E shows another exemplary user interface of the ecosystem of FIG. 1.

FIG. 10A shows another exemplary user interface of the ecosystem of FIG. 1.

FIG. 10B shows another exemplary user interface of the ecosystem of FIG. 1.

FIG. 10C shows another exemplary user interface of the ecosystem of FIG. 1.

FIG. 11 shows another exemplary user interface of the ecosystem of FIG. 1.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the terms “user” and “consumer” can be used interchangeably to include any person utilizing the ecosystem to communicate with others in an online setting. The terms “advertiser” “company” and “business” are used interchangeably to describe any individual, group or legal entity that is promoting, selling or otherwise providing items of commerce such as goods, services, content and/or information to consumers within the ecosystem. To this end, the advertisements by these advertisers can include information about these items of commerce, and/or any type of information to which the Advertiser desires to disseminate to site users.

The term “publisher” can include any individual, group or legal entity having a consumer interface through which a portal can be placed for allowing communication between an advertiser and user. In the preferred embodiment, the publishers own website can act as the publishers' consumer interface. However, other consumer interfaces can include, for example, mobile applications, smart TV applications, TV channels, and/or radio stations, for example. Regardless of the type of interface, the publisher can participate within the ecosystem by becoming a member of the below described Publisher Platform.

As described herein, the terms “site owner,” “system management” and/or system administrator” are used interchangeably, and can include an individual, group or legal entity that is overseeing, providing and/or performing the method and system steps disclosed herein, and that coordinates and manages the ecosystem. In this regard, embodiments of the system and method can be performed on an ecosystem website entitled “GotChosen.com.” However, the inventive concepts disclosed herein are not limited to implementation on a website or to a website having any particular name or URL address. As such, the below described functionality can be performed in any number of different manners and can utilize any number of different mediums ranging from one or more websites, portals, web applications, mobile applications, website URL's, computer networks, mobile devices, smart TVs, and/or video games, for example, without limitation.

The terms “communication portal” and “portal” can be used interchangeably to describe an interface for allowing two way direct or indirect communication between system users and advertisers within the ecosystem. As will be described below in detail, preferred embodiments of the system can include an “ad portal” and a “content portal.” The ad portal can function to display products and services from advertisers to site users based on the site users disclosed preferences, and can also provide functionality for allowing direct interaction with one or more representatives of the advertiser, in order to receive additional information about the products or services, and/or to facilitate a purchase of the same. During this interaction, and with the consumers permission, the advertisers' representative can make changes to the contents of the portal being viewed by the consumer on the consumer device.

Likewise, the content portal can function to allow site users to interact with one another, and to share any type of content such as text, video, pictures and the like. Both the content portal and the ad portal can further allow two-way communication between the site users and/or advertisers when site users are browsing external websites participating in the Publisher Platform, and without requiring users to leave the publishers' website.

In this regard, the portals can be created by a generation module of the ecosystem server utilizing any form of computer readable language, such as JavaScript or IFrame, for example, that can be placed or embedded onto one or more publisher websites, for example, and/or web or mobile applications in order to allow the above described two way interaction without requiring the user to ever leave the publishers site. These two way interactions can be in the form of an online chat, video or instant message, as well as other known communication mechanisms. Moreover, the ad portal can further include functionality for allowing an advertiser representative to change the images presented on a consumers screen within the ad portal, and both portals can offer full search capability.

Systems and methods for providing online advertising utilizing user-centric interaction with companies, products, services and content can be performed as and within an online ecosystem that features the User Platform, Advertiser Platform, and Publisher Platform described below in detail. The ecosystem can also include any and all hardware and/or software elements which can be utilized to create the above noted portals and platforms in order to implement and/or sync communication between the same.

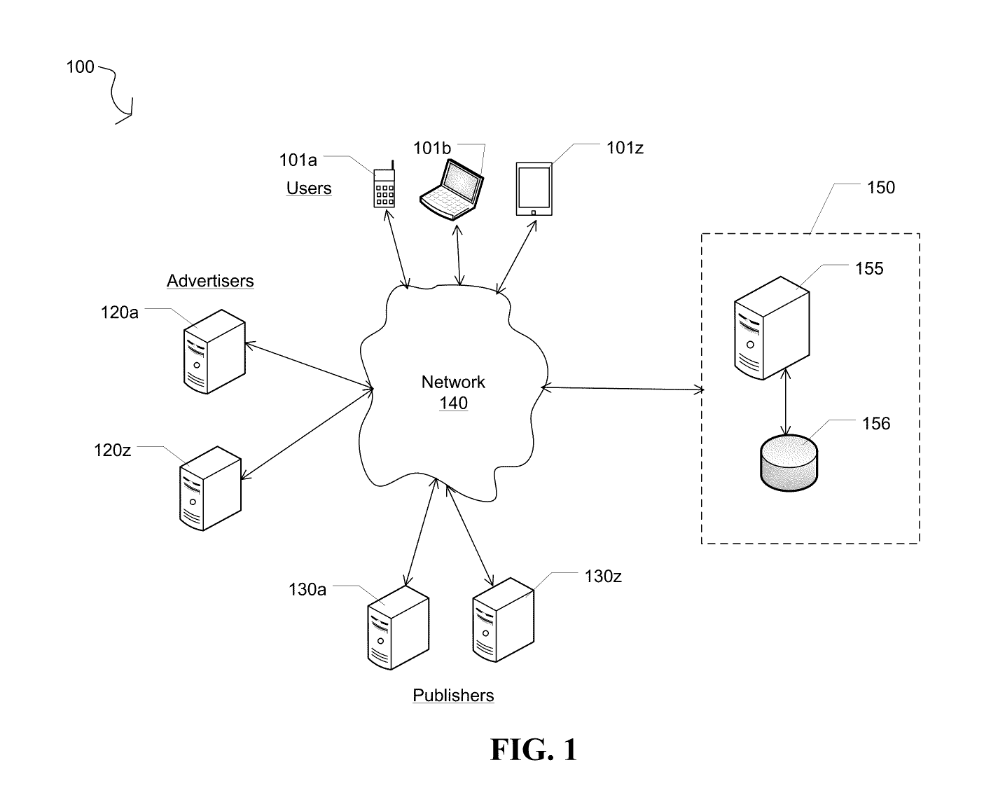

FIG. 1 is a schematic illustration of an exemplary system operating environment 100 for implementing the ecosystem. The system 100 can include one or more user interface devices 101a-101z, one or more advertiser devices 120a-120z, and one or more publisher devices 130a-130z that are connected over a network 140 to an ecosystem server 150.

The ecosystem server 150, according to one embodiment, can include one or more individual computing devices 155 that can be connected to one or more databases 156 on which various portions of the ecosystem platform can reside. The ecosystem server 150 can function to provide a central hub for controlling the communication between the user interfaces 101, the advertiser interfaces 120 and the publisher interfaces 130, through any number of different mediums such as the above noted ecosystem website, for example.

In this regard, portions of the ecosystem can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., Javascript) and/or machine code, and the computer program can be deployed in any form, including as a stand-alone program or as a subroutine, element, or other unit suitable for use in a computing environment.

In general, computer-readable storage mediums, such as the database 156, include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. In addition, the devices can be operatively coupled to a communications network, such as network 140, to receive instructions and/or data from the network and/or to transfer instructions and/or data to the network.

Each of the one or more user interface devices 101, the advertiser devices 120 and the publisher devices 130 can be a computing device that is operated by a registered user, advertiser and publisher, respectively, or an approved agent thereof. A computing device refers to any device with a processor and memory that can execute instructions. Computing devices include, but are not limited to, personal computers, server computers, portable computers, laptop computers, personal digital assistants (PDAs), e-Readers, cellular telephones, e-mail clients, tablets and other mobile devices. In either instance, each of the computing devices can include one or more client applications, such as a conventional web browser, for example, which can allow the device user to communicate with other device users and/or the ecosystem server 150.

In various embodiments, the network 140 is a transmission medium that facilitates any form or medium or digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), infrared transmissions, Blue Tooth or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

### Advertiser Platform

The Advertiser Platform refers to the group of advertisers within the ecosystem. Members of the Advertiser Platform can present relevant advertisements to particular consumers based on the stated interests of the consumer themselves. To this end, the ecosystem server can provide Advertising Platform members with functionality for presenting the advertisements, as well as functionality for allowing direct communication between the consumer and one or more advertiser representatives. In this regard, each advertiser can create sub accounts within the system for different tiers of management. Each advertiser representative can utilize an interface for conducting interactions with multiple users at a single time. Such a feature enabling the advertisers to provide information about their products and services, as well as the opportunity to facilitate sales of the same.

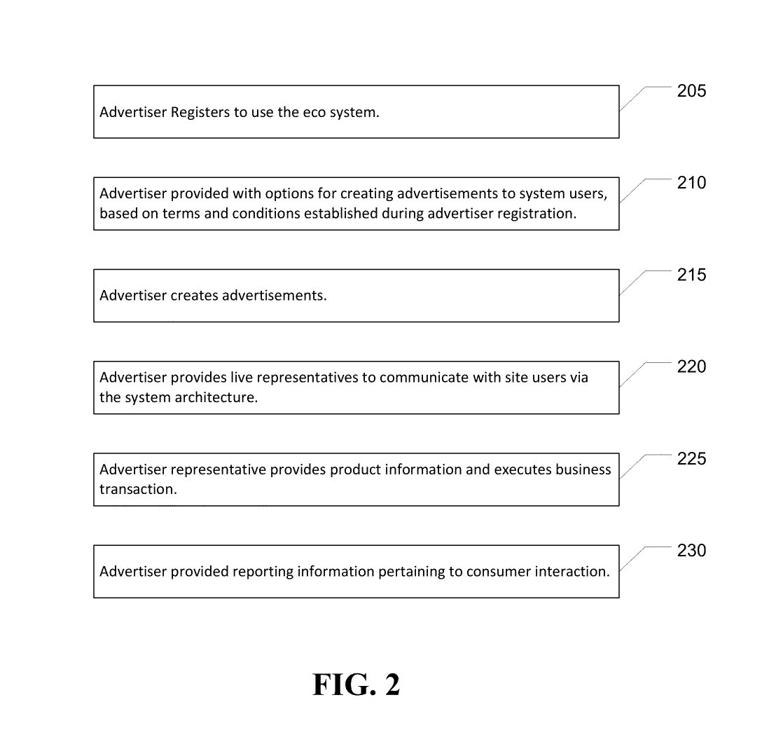

FIG. 2 is a flow chart illustrating an exemplary method for which an advertiser can join the Advertiser Platform and participate within the ecosystem. The method can begin at step 205 wherein perspective advertisers can register to participate with the ecosystem and agree to any required terms and conditions before being able to interact with system users. In one embodiment, registration can be accomplished through the ecosystem website, for example, however other registration mediums are also contemplated. Although outside the scope of this document, any number of legally permissible financial arrangements can be established between the site owner, advertisers and publishers, so as to be mutually beneficial.

Once registered, advertisers can be provided with options for creating unique and/or global marketing campaigns (step 210) that can be directed towards users of the ecosystem who indicate a desire to learn more about such items. Next, the advertiser can create any number of different marketing campaigns (step 215). These campaigns can include one way communications, such as banner ads, for example, that provide basic information about particular goods and services offered by the advertiser. Additionally, campaigns can also include additional information such as advertiser sale events, coupons and/or reward program information, for example.

Moreover, advertiser marketing campaigns can also include two-way direct consumer contact (step 220) through a live representative, for example, utilizing a variety of system supplied functions. For example, advertisers can enjoy real-time two way interaction with interested consumers through, an ad portal that can be located on a publisher's website, wherein specific questions by the site user can be answered and/or product sales can be made (225). As described herein, the real time two way interactions can include click to talk and/or text communication resources capable of allowing immediate communication between advertiser representatives and site users, and/or multiple site users at the same time. Specific subsystems and methods containing program code for performing direct communication between users in an online setting are known in the art and need not be duplicated herein.

Although described above as including live communication options, advertisers can also be provided with options for establishing automated answers for the most common user questions, as well as a suite of e-commerce solutions which can be provided through the ecosystem server as an e-commerce module, in order to facilitate and execute transactions within the ecosystem. In one nonlimiting example, the ecommerce solutions can include credit card processing and/or access to third party payment systems such as PAYPAL, for example. Moreover, advertisers can provide consumers with gift cards and/or any tangible or intangible product, which can target the desired market based on demographics, recent sales, geographic location, market segments and other such information. The system can allow a single advertiser representative to communicate with a plurality of different site users at the same time, thereby allowing advertisers to host online information sessions, seminars and/or auctions for specific products and services.

Finally, the system can provide advertisers with one or more management system tools capable of producing periodic and/or real time reports (step 230) based on information such as: marketing campaigns, company staff members, user interactions, inventory control, reward programs, overall user and market feedback, etc., all of which can help the advertiser company to analyze the data and launch more effective marketing programs, thus maximizing ROI.

### Publisher Platform

The Publisher Platform refers to the group of publishers within the ecosystem. Members of the Publisher Platform can position one or more portals within their interface (e.g., website) for use by the ecosystem. As noted above, the portals can preferably include one or more ad portals displaying the user centric advertisements from advertisers to site users, as well as content portals for displaying user generated information via the social exchange. Portals can be generated by the ecosystem server and can be optimized for the particular type of publisher interface being used. For example, portals can be customized to include any size and shape that can be displayed on a publishers website, mobile site and/or mobile app, for example. In exchange for participating in the Publisher Platform, publishers can receive any type of compensation, such as financial incentives and/or rewards including commissions for transactions that take place on the publisher interface through the ad portal or as a flat fee for simply participating in the program, for example.

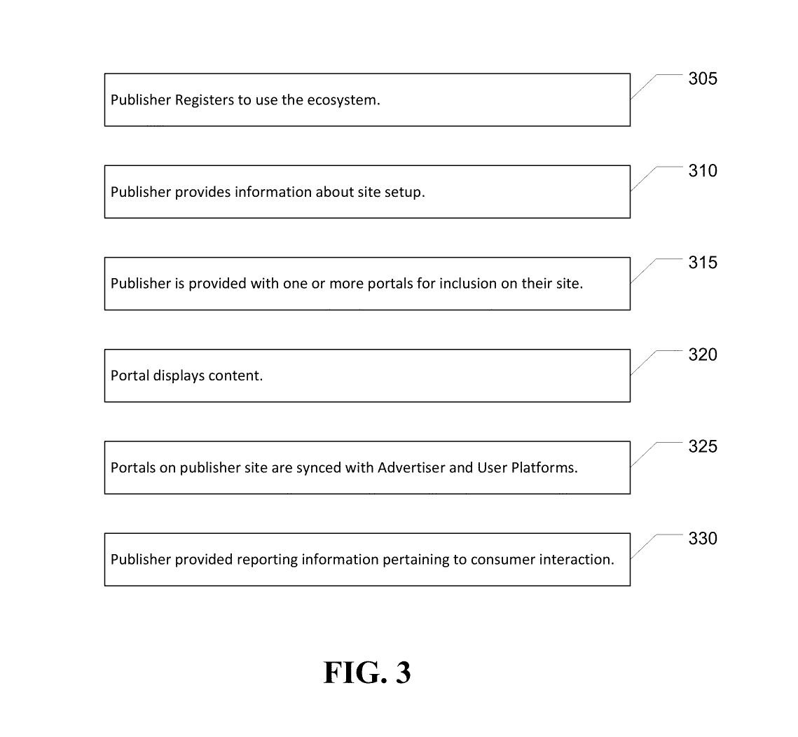

FIG. 3 is a flow chart illustrating an exemplary method for which a publisher can join the Publisher Platform and participate within the ecosystem. The method can begin at step 305 wherein perspective publishers can register to participate with the ecosystem and agree to any required terms and conditions. Once registered, or as a part of the registration process, the publisher can provide information about their interface (step 310) to enable a system administrator to generate the portals for inclusion on the publisher interface.

Next, the publisher can be provided with one or more portals (step 315) in the form of program code, for example, that is complementary to the programming language of the publisher website, in order to allow the publisher to display one or more fully functional portals, as described above. Once positioned onto the publisher's website, the portal can display content (step 320) to site users who are logged in to the ecosystem network, and visit the publisher website. In this regard, the portal can identify that a particular interface user is registered with the ecosystem and can then display relevant advertisements to the user based on the users' pre-defined preferences.

Each of the portals loaded onto the publisher's interface can also include programming for maintaining communication with the ecosystem server in order to remain in sync (step 325) with the Advertiser Platform and the User Platform, and each of these platforms can constantly communicate to ensure relevant ads are being provided for each visitor to a given publisher site. Finally, publishers can be provided with functionality for generating full reports (step 330) pertaining to the user and advertiser interactions that occur through the portals contained on the publisher interface.

### User Platform

The user platform (also referred to as the social exchange platform) functions to provide a complete social media network for and between individual site users. The user platform can include functionality for allowing users to provide information about themselves and their preferences which can be used to facilitate communication with others via the social exchange platform and the system portals such as the content portal and the ad portal, for example.

In one embodiment, members of the user platform can be provided a fully functional social media platform (social exchange platform) that can be hosted by the ecosystem server and accessed via the ecosystem website. The social exchange platform can allow users to participate in an online community, generate online connections, make friends, and share media content. In one embodiment, the social exchange platform and the content portal can include a plurality of different menus, tabs and/or channels where users can initiate any type of interaction such as text, image, video, and/or audio with other users and/or advertisers. In one embodiment, the channels can be user generated content and can be 100% controlled by the site users.

The user platform can also provide site users with options for controlling their settings. For example, the amount of relevant advertising presented to site users can be based on a subscription status, for example, wherein non-paying members have a lower level of control when compared to members who have a paid membership. In this regard, site users can specify the type and amount of advertisements they wish to receive and can even specify which particular advertisers they wish (or do not wish) to interact with.

As such, the User Platform can allow a site users to anonymously search the ecosystem for other users, companies, products, services, reward programs, and/or general information and be shown the results in the form of advertisements that can trigger live two way communication with representatives of an advertiser.

Therefore user platform can also allow site users to control features relating to their content portals which can be displayed on publisher websites. Additionally, site users can utilize content portals to engage the social exchange platform and to communicate with other members while visiting external publisher sites via the content portal. Of course, users can also interact with selected advertisers via the ad portal, while participating in the social exchange platform hosted by ecosystem server and can also communicate with selected advertisers when surfing the internet and visiting external publisher websites that are members of the Publisher Platform.

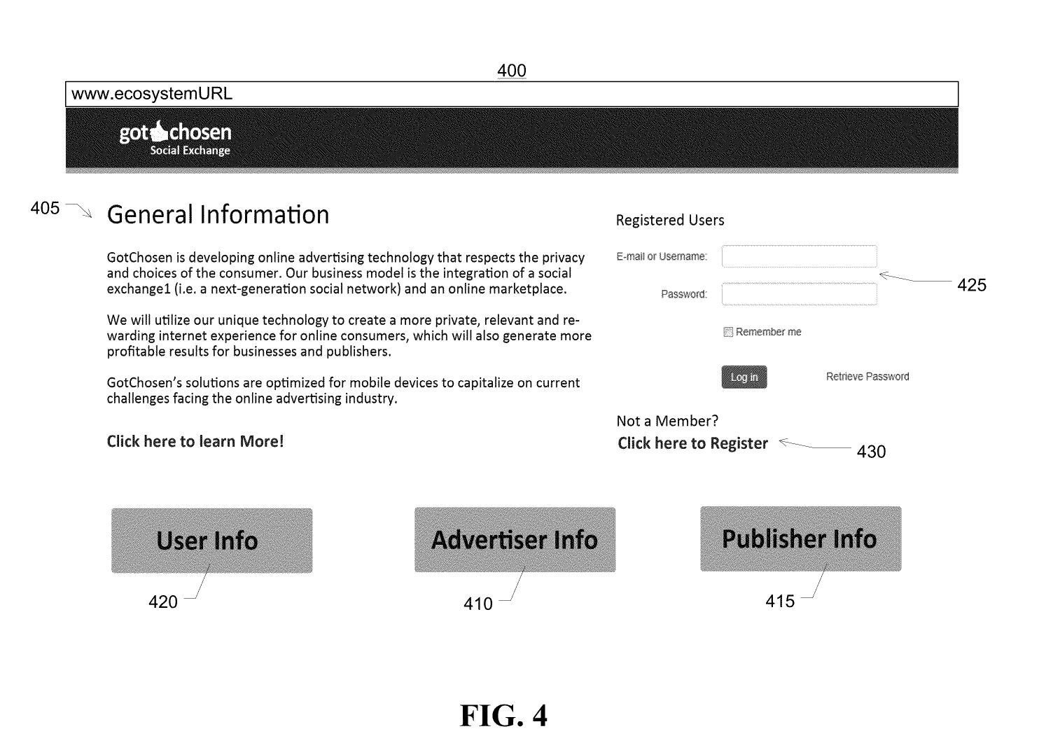

FIGS. 4-11 present exemplary user interfaces of the ecosystem 100 of FIG. 1, for providing online advertising utilizing user-centric interaction with companies, products, services and content. In one embodiment, the below illustrated presentation screens can be generated by the ecosystem server 150 and displayed on one or more user interface devices 101. Although illustrated in the form of a website and website pages, this is for illustrative purposes only, as the inventive concepts disclosed herein can be implemented across a wide variety of different platforms without deviating from the scope and spirit of the inventive concepts disclosed herein.

FIG. 4 illustrates an exemplary user interface generated by the ecosystem server 150 to be displayed to one or more users 101. In this example, an opening page 400 is generated in response to a user navigating to the ecosystem website URL. This opening page 400 can include, for example, general information 405, as well as specific information pertaining to Advertisers 410, Publishers 415, and/or site users 420, as well as providing a brief synopsis of the ecosystem and the potential benefits of accessing the same.

To this end, the presentation screen 400 may list basic information pertaining to how the ecosystem allows individual users to communicate with each other in a social exchange setting, as well as providing a list of participating advertisers and publishers, for example. Additionally, the screen may list benefits for participating within the ecosystem, such as a listing of member only discounts, reward programs and the like. Finally, the screen may provide options for registering new users 425 or for allowing previously registered members to login 430.

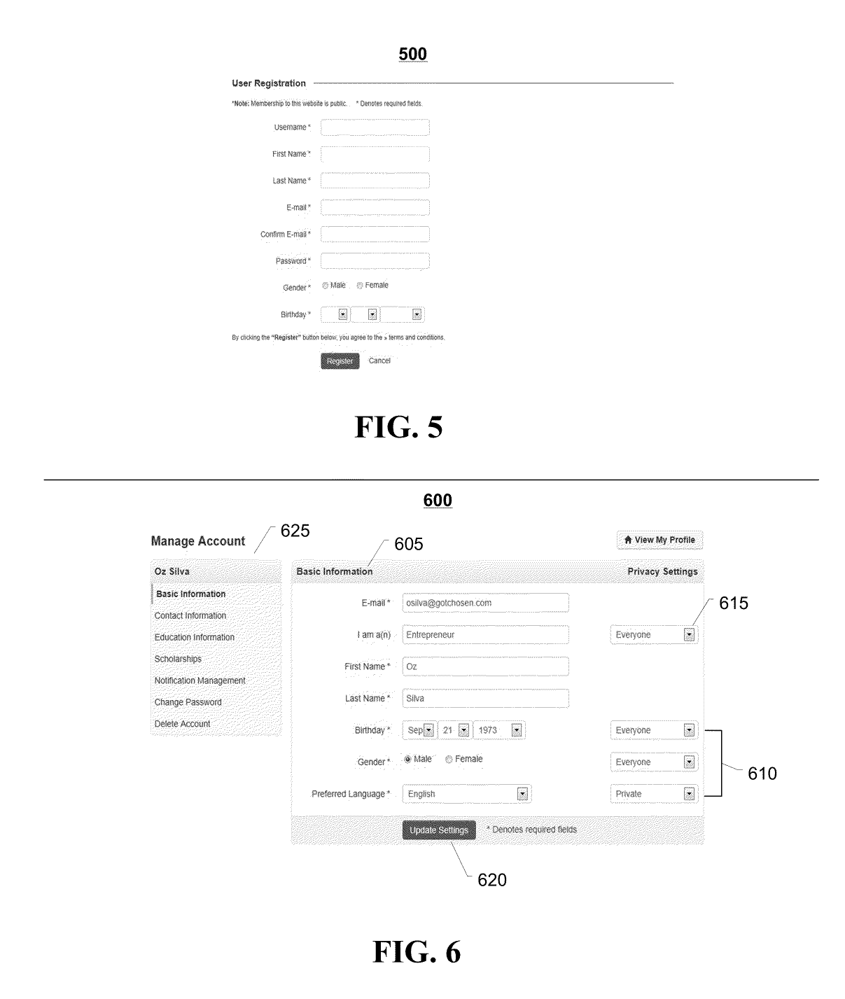

FIG. 5 illustrates an exemplary registration screen, wherein users who have not previously registered with the system, the user can be taken to a separate registration page 500 where they can create a user account. Once the account has been created, a user profile page 600 can be generated for the user to establish their profile options, as shown in FIG. 6.

For example, the user profile page can include options for allowing users to provide basic information about themselves 605 as well as to set privacy options 610 specifying what information can be shared with other site users. In various embodiments, site users can be provided with options for creating a personal profile, a public profile and a preferences profile, wherein both the personal and preference profiles can constitute information that is not made available to other site users and can be marked as private information stored within the system database. Such a feature can allow site users to remain partially anonymous or completely anonymous while participating in the social exchange platform and via the content portal when utilizing a publisher's website. To this end, the user can be provided complete control over the privacy of their information and can change these settings between private or public at any time 615. Whenever a change is made, the corresponding permissions can be synced 620 with both the Advertiser Platform and the Publisher Platform in real time or near real time.

In addition to the above, the user profile page can include additional information and/or account management options 625 including, but not limited to, contact information, education information, scholarship information, notification management options, password changes, and account deletion and/or suspension.

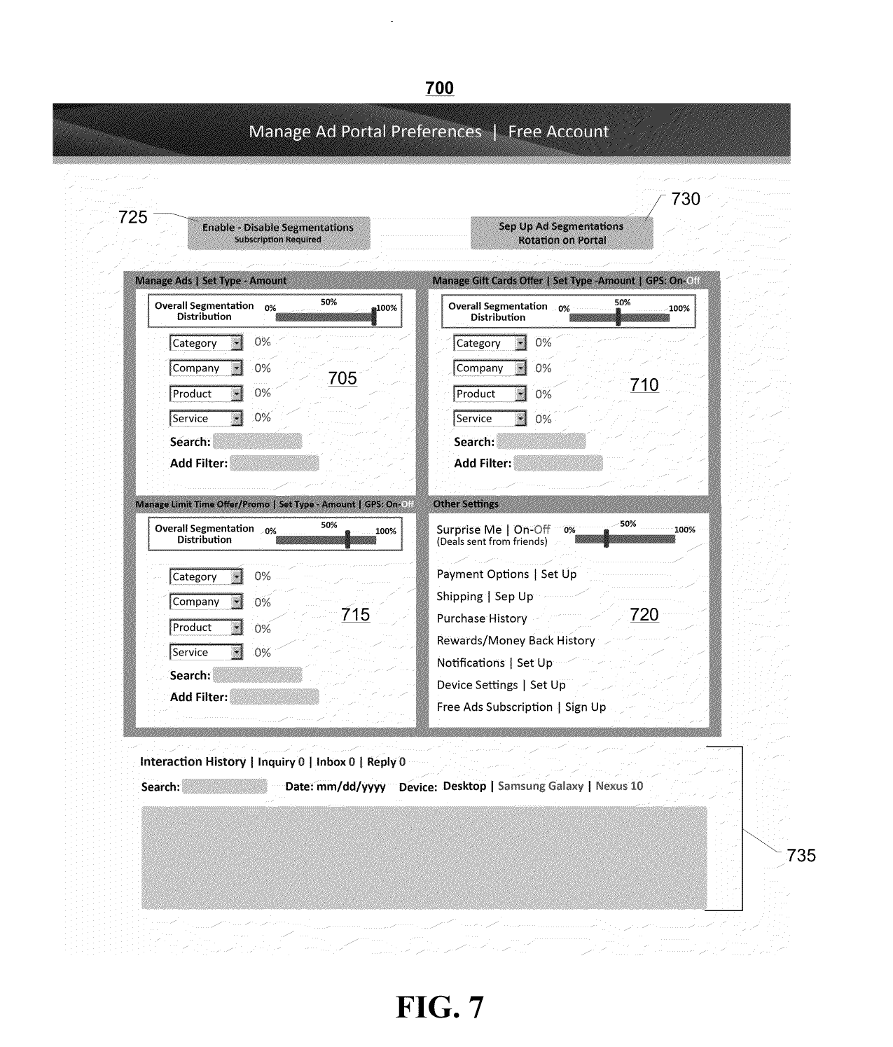

FIG. 7 illustrates an exemplary ad portal preferences page 700 for allowing users to input their advertising preferences in receiving information about products and services that are available from members of the Advertising Platform. For example, the user can be provided with options 705 for managing advertisements they receive, as well as specifying the type and amount of the same. These options can include the ability to specify particular types and categories of products and services they are interested in receiving information about. The user can also select particular companies and/or service providers to whom they would like to interact with, as well as those that the user does not wish to interact with. In this regard, users can continually update their preferences in order to learn information about products and services that are relevant to them. For example, if a user is contemplating purchasing new shoes, he or she can indicate the same within the preferences page, in order to allow Advertisers to provide them with information about the shoes they sell.

In one embodiment, the ecosystem server can include a comparison module that functions to compare the advertiser preferences inputted by each specific user with the information and advertisements available through the Advertiser Platform. Once the comparison is made, only those advertisements which fall within the users specified advertiser preferences can be displayed to the user through the ad portal. As such, each users ad portal will display relevant advertisements to that user based on the preferences entered by the user themselves. In one nonlimiting example, the ecosystem can generate a list of the appropriate advertisers and display those advertisements to the user in a rotating manner, wherein each appropriate add is displayed according to a set schedule.

The user can also be presented with options 710 and 715 for receiving information from advertisers that are offering special incentives such as gift cards, loyalty points, rewards programs and the like, as well as limited time offers and special promotions. These offers can provided by advertisers across the entire Advertiser Platform, or from advertisers located within a user specified geographic area, such as the users' zip code and/or GPS information which can be provided to the system by the users' portable device.

Additional user options 720 can also be provided for allowing the user to setup any form of preferred payment methods and/or banking information in order to execute transactions through the system, as well as to provide loyalty and/or reward program information. Within this category, the user can enable a “surprise me” category wherein the user can also receive advertisements that were recommended to the user from other site users and/or the system administrator. As noted above, options for allowing the user to control the amount 725 and rotation 730 of advertisements can be provided. In one embodiment, the amount of control offered to the user can be dependent on a subscription level. Finally, the user can be provided options for searching previous interactions with specific advertisers and/or their representatives, as shown at 735.

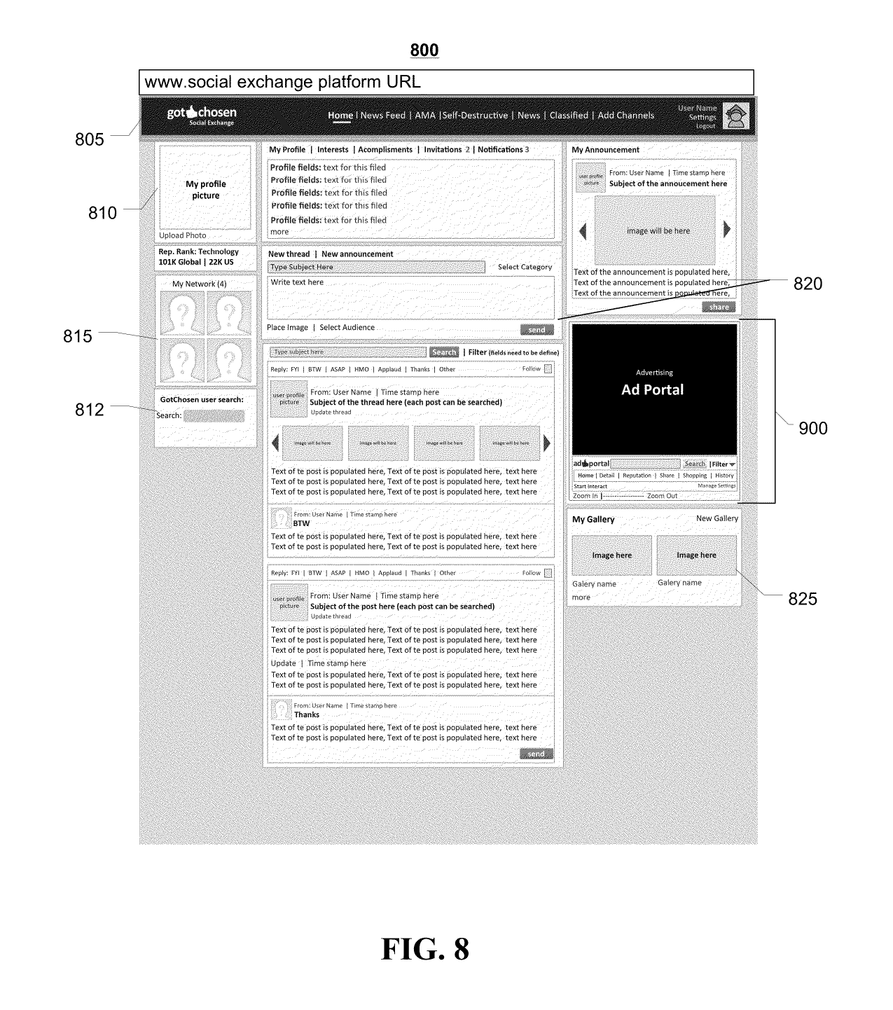

FIG. 8 illustrates one embodiment of an exemplary social exchange website page of the user platform 800. The social exchange can be a 100% community driven social media site wherein users can participate in a virtual community. In this regard, the social exchange can include a content navigation header 805 for presenting a plurality of different site categories ranging from the social home screen to news feeds, to classified ads that are created by other users, and user created channels, for example. As will be noted below, the content header 805 can also be displayed on publisher websites via the content portal in order to access the social exchange platform.

Within the home screen 800, users can be provided with their user account options 810, search options 812 for allowing users to search the network for other site users based on any number of search criteria, as well as to establish a private network 815 of chosen friends. Once connected, site users can communicate 815 via any number of traditionally employed social media communication mediums such as message boards, instant messages, private and public chat rooms, email, as well as voice and video chat sessions through any number of integrated and/or plugin applications. In this regard, users can upload, download and share any type of information 825 such as text, images, video and audio, for example.

In addition to the user communication and interaction described above, various screens within the social exchange can also include an ad portal 900 for enabling users to view relevant advertisements and to interact in real time (but not limited to real time) with advertisers from the Advertiser Platform.

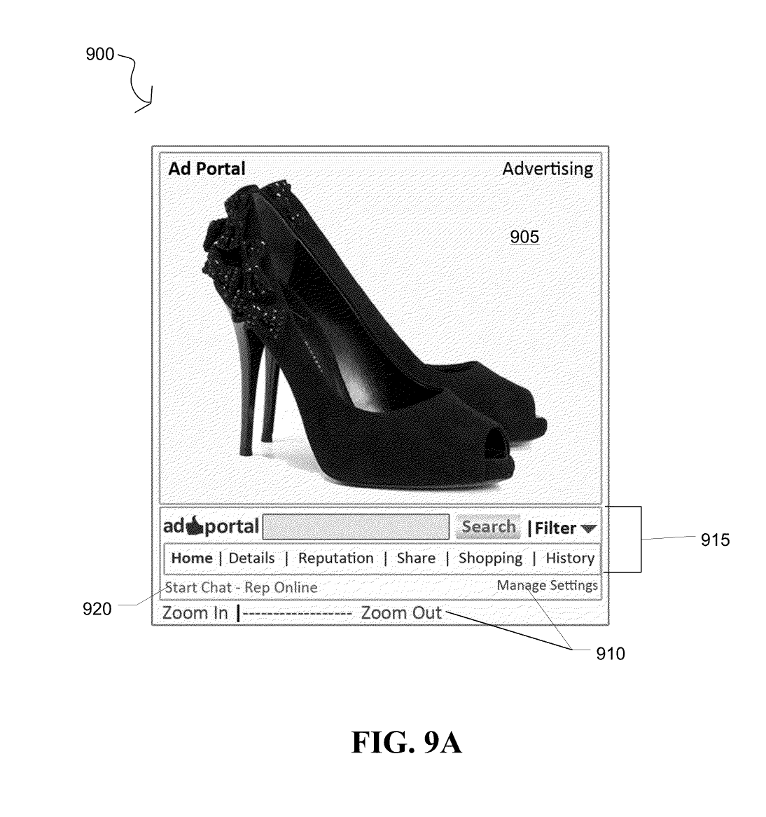

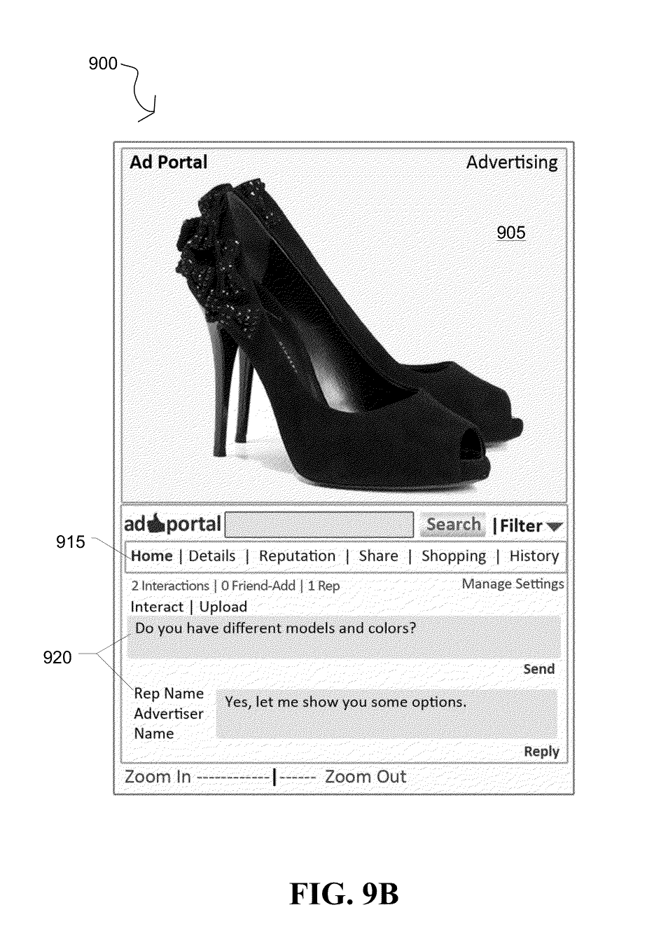

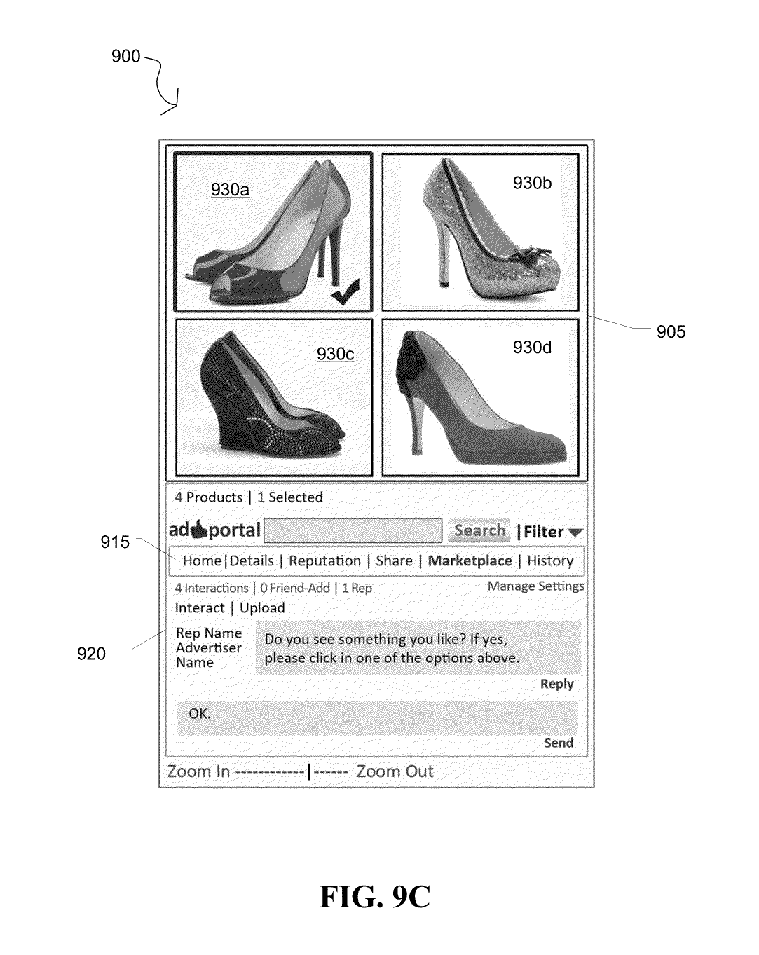

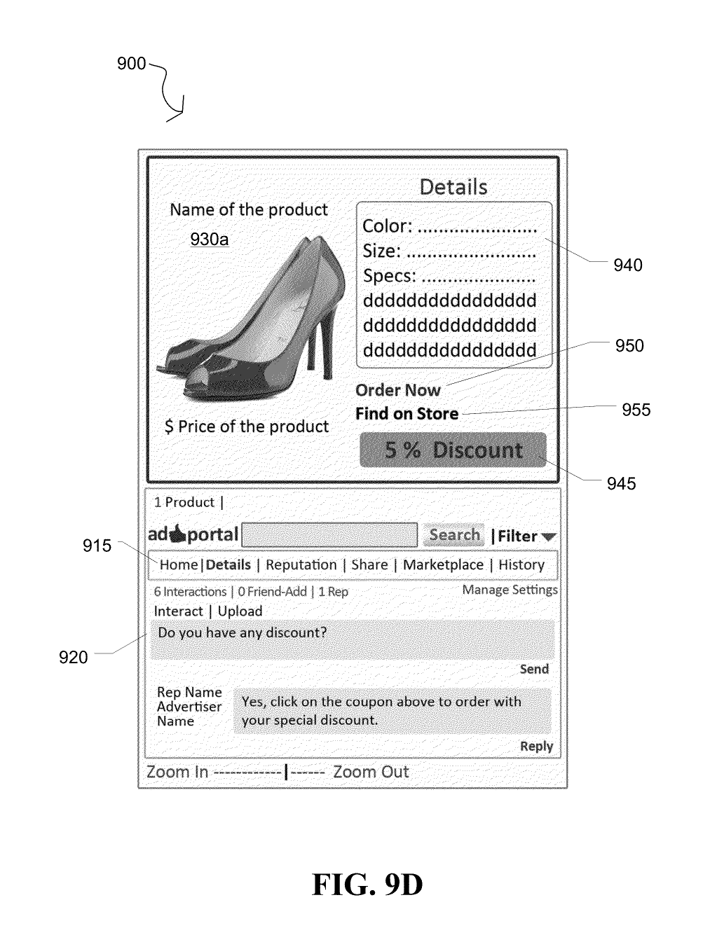

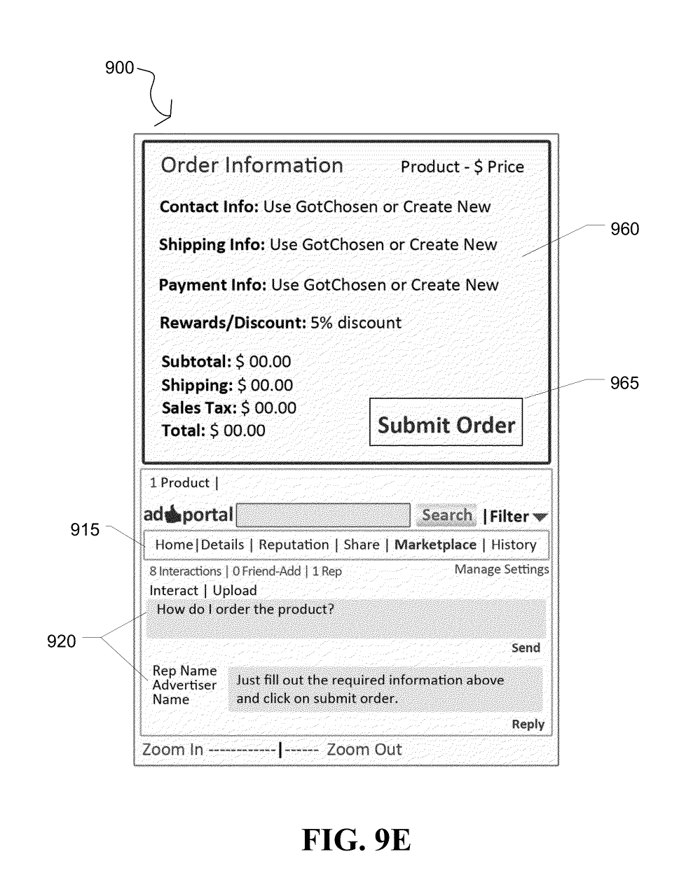

FIGS. 9A-9E illustrate exemplary presentation screens which can be displayed by the ad portal in accordance with one embodiment of the invention. As shown in FIG. 9A, the ad portal 900 can display a rotating series of advertisements 905 in the form of a banner image, for example, having any number of pictures, text, and/or audiovisual elements, for example. Beneath the advertisement, a user management section 910 can be provided to allow a user to control the operation of the portal.

The advertisement 905 displayed to a particular user will be dependent on the specific information provided by that user in their ad portal preferences page, as described above with respect to FIG. 7. In this regard, only those advertisers, products, services and/or categories of the same that have been pre-selected by the user will be displayed to a particular user within their ad portal 900. In the present example, the user has expressed an interest in women's footwear, and is being shown an advertisement 905 for a woman's dress shoe.

Beneath the advertisement image, the user can be presented with search options 915 for learning more information about the particular shoe, and/or the advertiser that is offering the shoe for sale. Additional search capabilities can include the ability of the user to search for another service or product not linked with the current advertisement. The search can be based on different criteria, and the displayed results can offer the option to take the user directly to other ad content.

In addition to the above, the user can be provided with one or more forms of contact options 920 for engaging a representative of the advertiser who can provide the user with additional information. In the embodiment illustrated in FIG. 9B, the user can engage a live representative from the advertiser via a chat feature 920, for example, wherein a two way dialogue can begin. In the present example, the user can request assistance from the advertiser in selecting additional colors and models of the displayed shoe.

Although described above as communicating through a two way chat session, other communication methodologies such as voice and/or video chat are also contemplated. Functionality for performing each of these communication methodologies within the ad portal can preferably be provided within the coding of the ad portal itself.

As shown in FIG. 9C, the advertiser representative can provide additional options to the user based on the user's request. For example, the advertiser representative can present the user with additional shoes 930a, 930b, 930c and 930d, for example, and can display the same to the user within the advertisement section 905 of the ad portal. Such a feature can allow the advertiser to change what the user is viewing on their screen by replacing the rotating advertisement 905 with actual products based on the user's request.

As shown in FIG. 9D, the user can select one of the displayed products, for example shoe 930a, that was provided by the advertiser representative. Once the item has been selected, the portal 900 can display additional information 940 about the selected product, such as the product name, manufacturer, size, color and price, for example. Additionally, the user can be provided with coupons and/or discounts 945 which can be used to purchase the product through the ad portal 950 or at a local store 955.

In the event the user wishes to purchase the item at a local store 955, the advertiser representative can display local stores offering the selected product based on the user's geographic information presented in their ad portal preferences page, as described above with respect to FIG. 7.

Moreover, as illustrate in FIG. 9E, should the user choose to purchase the selected item immediately, the sales representative can conduct the transaction through the ad portal. In this regard, the user can provide their purchase information 960 which can include a specific payment method and/or shipping address, or they can use their default information provided in their User account, as described above with respect to FIG. 7. Once the information has been confirmed, the user can submit their order 965 and the item(s) can be shipped directly from the advertiser to the user's selected destination.

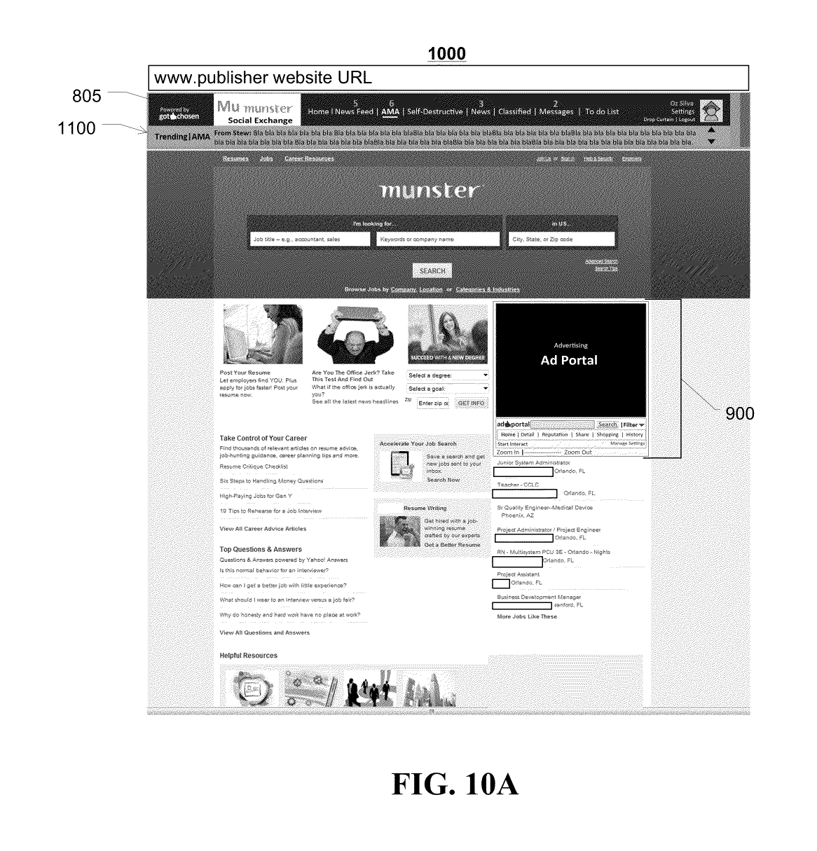

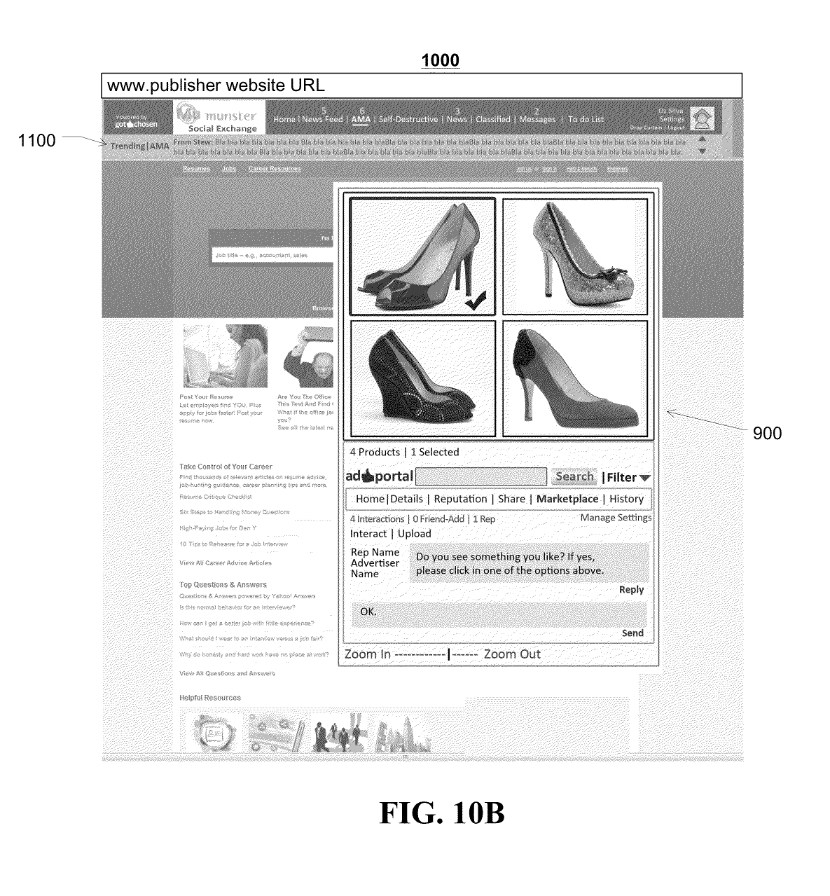

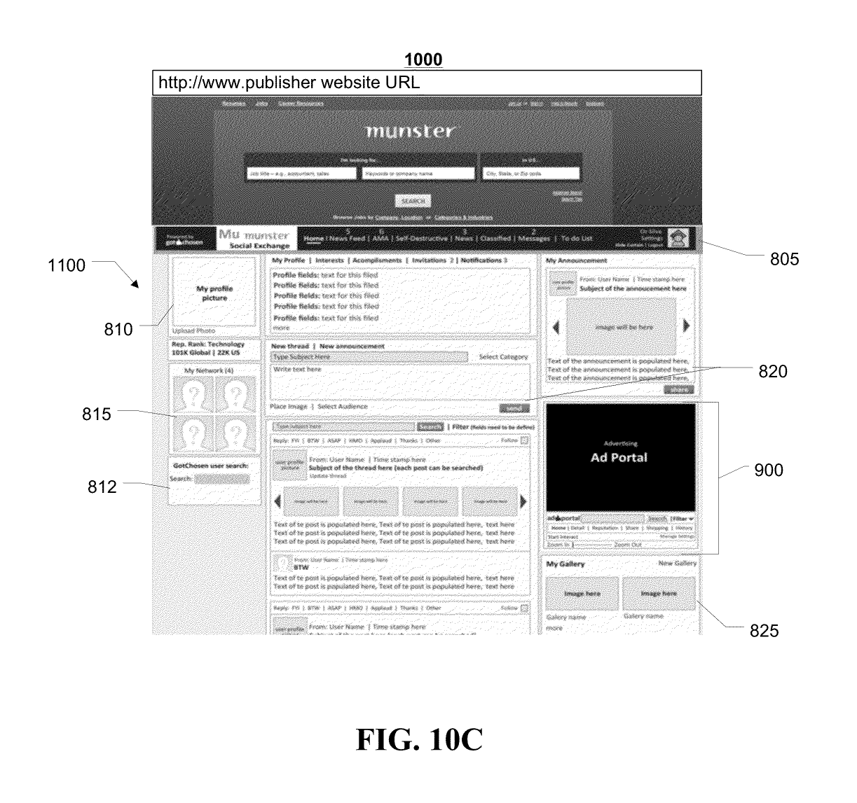

FIG. 10A illustrates an exemplary presentation screen of a publisher website 1000 that includes the ad portal 900 and a content portal 1100. As shown the content portal 1100 can preferably be displayed on the publisher's website as the content navigation header 805 described above.

In order for the user to interact with either the content portal 1100 or the ad portal 900, the user should be registered with the user platform and logged in to the system 100 prior to navigating to the publisher's site. When this happens, the user's profile on the User Platform can sync with the Advertiser Platform and the Publisher Platform in order to display the users social media interface and the advertising, as described above.

As shown in FIGS. 10B and 10C, both the content portal and the ad portal can be accessed by the user as described above with respect to FIGS. 8 and 9 in order to communicate with other site users and/or to view advertisements and communicate with selected advertisers, without requiring the user to ever leave and/or be redirected from the publisher website.

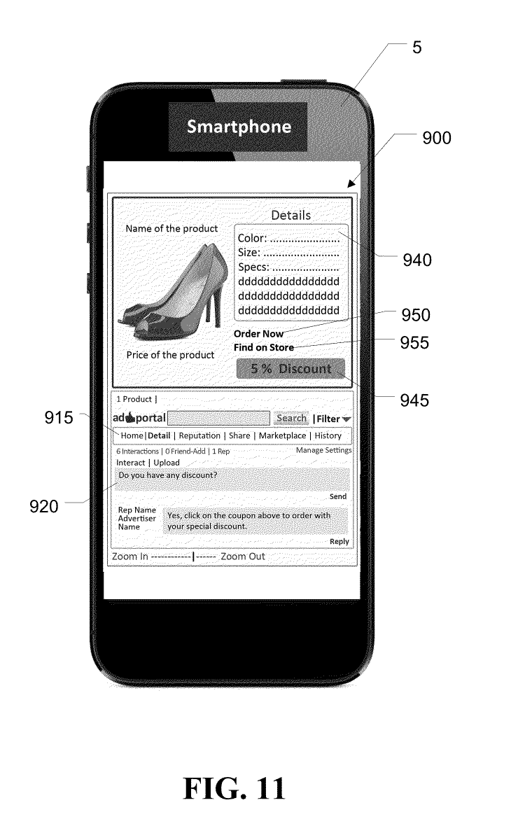

As noted above, the ad portal and content portals can be configured for use with and by any form of processor enabled device. Accordingly, FIG. 11 illustrates an exemplary ad portal which can be integrated into a publishers interface comprising a mobile app, for display on a users' mobile device 5. Of course, many other forms and types of interfaces are also contemplated.

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

Accordingly, a novel system and method for achieving user specified online advertising in a manner that greatly benefits consumers, advertisers and publishers is disclosed. As to a further description of the manner and use of the present invention, the same should be apparent from the above description. Therefore, no further discussion relating to the manner of usage and operation is provided.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for conducting user centric advertising and multiuser communication, the method comprising:
providing, by an ecosystem server, a communication interface between one or more advertiser devices and one or more user devices;
providing an online social exchange platform on the ecosystem server, said platform including a content navigation header and an ad portal;
receiving, at the ecosystem server, information from a first user device, said information including an advertising preference;
receiving, at the ecosystem server, information at least one of the advertiser devices, said information including one or more advertisements;
comparing, by the ecosystem server, the received advertisements with the received advertising preference from the first user device;
generating, by the ecosystem server, a list of approved advertisements for the first user device based on the comparing; and
displaying at least one of the approved advertisements to the first user device via the ad portal.

2. The method of claim 1, wherein the ad portal includes functionality for performing two way communication between the first user device and each advertiser device having an advertisement on the list.

3. The method of claim 2, further comprising:
establishing, by the ecosystem server, direct communication between the first user device and at least one advertiser device via the portal.

4. The method of claim 3, wherein direct communication includes at least one of a text communication, a voice communication and a video chat.

5. The method of claim 4, wherein the ad portal further includes functionality for allowing the advertiser device to change a displayed advertisement in the ad portal that is being displayed to the first user device.

6. The method of claim 5, wherein the ad portal further includes functionality for conducting an e-commerce transaction.

7. The method of claim 1, wherein the ad portal includes functionality for allowing each of the one or more user devices to adjust at least one of an amount and a duration of the approved advertisements displayed on the ad portal.

8. The method of claim 1, further comprising:
providing, by the ecosystem server, a plurality of site categories within the social exchange platform for receiving content from each of the one or more user devices;
providing a plurality of communication mediums within the social exchange platform for facilitating direct communication between each of the one or more user devices; and
providing options for navigating the social exchange platform within the content navigation header.

9. A computer implemented method for conducting user centric advertising and multiuser communication, the method comprising:
providing, by an ecosystem server, a communication interface between one or more advertiser devices, one or more publisher devices and one or more user devices;
generating, by the ecosystem server, ad portals for dissemination to each of the one or more publisher devices;
receiving, at the ecosystem server, information from a first user device, said information including an advertising preference;
receiving, at the ecosystem server, information from at least one advertiser device, said information including one or more advertisements;
comparing, by the ecosystem server, the received advertisements with the received advertising preference from the first user device;
generating, by the ecosystem server, a list of approved advertisements for the first user device based on the comparing;
determining, by the ecosystem server, that the first user device is communicating with a first publisher device; and
sending, by the ecosystem server, at least one of the approved advertisements to the ad portal of the first publisher device.

10. The method of claim 9, further comprising:
establishing, by the ecosystem server, direct communication between the first user device and at least one advertiser device, said communication conducted through the ad portal of the first publisher device.

11. The method of claim 10, wherein said direct communication between the first user device and the at least one advertiser device is performed concurrently with the communication between the first user device and the first publisher device.

12. The method of claim 10, wherein direct communication includes at least one of a text communication, a voice communication and a video chat.

13. The method of claim 9, wherein each ad portal includes functionality for allowing an advertiser device to change a displayed advertisement in the ad portal that is being displayed to the first user device on the first publisher device.

14. The method of claim 9, wherein each ad portal further includes functionality for conducting an Ecommerce transaction.

15. The method of claim 9, further comprising:
providing, by the ecosystem server, an online social exchange platform having a content navigation header and an ad portal embedded therein;
providing, by the ecosystem server, a plurality of site categories within the social exchange platform for receiving content from each of the one or more user devices;
providing a plurality of communication mediums within the social exchange platform for facilitating direct communication between each of the one or more user devices; and
providing options for navigating the social exchange platform within the content navigation header.

16. The method of claim 15, further comprising:
generating, by the ecosystem server, content portals for dissemination to each of the one or more publisher devices, each of said content portals including functionality for allowing a user device to engage the social exchange platform.

17. The method of claim 16, further comprising:
displaying the content navigation header of the first user device within the content portal of the first publisher device based on the determining.

18. A system for conducting a computer implemented method for receiving user centric advertisements and user communication, the system comprising:
an ecosystem server device configured to communicate with one or more advertiser devices, one or more publisher devices and one or more user devices over a network, said ecosystem server including
a generation module functioning to generate ad portals for dissemination to each of the one or more publisher devices;
a communication module functioning to receive information from a first user device, said information including an advertising preference, and to receive information from at least one advertiser device, said information including one or more advertisements;
a comparison module functioning to compare the received advertisements with the received advertising preference from the first user device, and to generate a list of approved advertisements for the first user device based on the comparing,
wherein the ecosystem server is adapted to determine that the first user device is communicating with a first publisher device, and to send at least one of the approved advertisements to the ad portal of the first publisher device.

19. The system of claim 18, wherein:
the communication module functions to establish direct communication between the first user device and at least one advertiser device through the ad portal of the first publisher device.

20. The system of claim 19, wherein the ecosystem server further includes:
an e-commerce module functioning to perform an e-commerce transaction between the first user device and at least one advertiser device through the ad portal of the first publisher device.
